(19) United States
(12) Patent Application Publication
(10) Pub. No.: US 2024/0377305 A1
(43) Pub. Date: Nov. 14, 2024

(54) METHOD, DEVICE AND USE THEREOF FOR MEASURING THE SIZE AND/OR CONCENTRATION OF PARTICLES OF A DISPERSION

(71) Applicant: Topas GmbH Technologie-orientierte Partikel-, Analysen- und Sensortechnik, Dresden (DE)

(72) Inventors: Lukas OESER, Dresden (DE); Rene ADAM, Dresden (DE); Andrea RUDOLPH, Dresden (DE)

(73) Assignee: Topas GmbH Technologie-orientierte Partikel-, Analysen- und Sensortechnik, Dresden (DE)

(21) Appl. No.: 18/655,512

(22) Filed: May 6, 2024

(30) Foreign Application Priority Data
May 8, 2023 (DE) 10 2023 111 793.9

(51) Int. Cl. G01N 15/0205; G01N 15/075

(52) U.S. Cl. CPC G01N 15/0211; G01N 15/075; G01N 2015/0222

(57) ABSTRACT

Methods for measuring the size and/or concentration of particles of a dispersion. The methods may comprise determining a time-dependent measurement of at least one scattered light signal. The methods may also comprise performing a computer-implemented regression function from an obtained frequency distribution of the time-dependent scattered light signal. Devices, and the uses thereof, for measuring the size and/or concentration of particles of a dispersion as also disclosed.

### CROSS REFERENCE TO RELATED APPLICATION

This application claims priority to German Patent Appl. No. 10 2023 111 793.9, filed on May 5, 2023, in accordance with 35 U.S.C. § 119(b) and 37 CFR § 1.55. The entire contents of DE 10 2023 111 793.9 is hereby incorporated herein by reference.

### BACKGROUND

The invention relates to a method for measuring the size and/or concentration of particles of a dispersion comprising a time-dependent measurement of at least one scattered light signal and an evaluation by means of a regression function from a frequency distribution of the time-dependent scattered light signal, as well as a device and the use thereof for measuring the size and/or concentration of particles of a dispersion.

Scattered light methods for particle measurement can be divided into single particle counting methods and collective evaluation methods. Collective evaluation methods are based on the fact that a plurality of particles are always evaluated simultaneously in the measurement volume. Single particle counting methods can simultaneously supply information relating to size and concentration. In contrast, collective evaluation scattered light methods can only supply information relating to either size or concentration of the particles, but not both simultaneously.

DE19628156A1 describes a device and a single particle counting method for measuring particle streams in a fluid. The device comprises at least one lighting assembly having an aperture and at least one receiver assembly having an aperture, wherein at least one aperture comprises an aperture opening having an edge which is convex with respect to the interior of the aperture. In the method, the particle stream is illuminated and/or viewed through an aperture opening having an edge which is convex toward its interior, wherein the maximum intensity of the particle flying through a first optical measurement region is measured and the particle is only taken into account if the intensity when flying through a second measurement region exceeds a certain minimum percentage of the maximum intensity measured for this particle.

DE102020100020A1 describes a method and a device for determining properties of particles, in particular the number distribution and concentration, by multiparametric detection of scattered light and extinction signals, in particular by determining the scattered light intensities for a different number of opening or receiving angles. DE 10 2020 100 020 A1 describes the realization as a single particle counter, wherein, in the multi-parametric detection of scattered light and extinction signals, particles are counted and simultaneously measured in at least two solid angle regions at high frequency, i.e., a number distribution is obtained, in particular by measuring at least two signals per particle.

Typically, collective evaluation scattered light methods are realized by means of photometers.

Publication EP1923694A2 discloses a method and a device for determining an oil quantity in a gas stream. In this case, light is radiated into or through the entire gas stream or a predetermined part of the gas stream. The oil concentration is determined as a function of the amount of light and/or the light intensity of the gas stream and as a function of the volume flow of the gas stream. The entire device is located in the gas flow, which is influenced thereby.

DE10008517A1 describes an optical measuring system for determining the concentration in particular of turbid liquid samples having a measurement volume for receiving the liquid sample to be measured, a plurality of photometer channels, which each have a light source and a light receiver on different sides of the measurement volume, and whose optical axes are arranged at different azimuth angles relative to the measurement volume, and an evaluation device, which determines the concentration of the liquid sample to be measured on the basis of the measurement values supplied by a plurality of light receivers belonging to different photometer channels.

U.S. Pat. No. 3,553,462A discloses a self-calibrating device for determining the radiation scattering properties of a fluid, wherein radiation from a first radiation source penetrates the fluid on a first straight path to a first radiation detector, and the radiation of a second source passes through the fluid on a second straight path to a second radiation detector. The outputs of the radiation detectors are combined to obtain the scattering coefficients.

DE102017121587A1 describes a method for simultaneously determining sample properties in the form of at least one characteristic value of a size distribution of particles in a fluid and a spectral refractive index profile (n(λ)) of the particles and/or of the fluid and optionally of a concentration of the particles in the fluid and a particle measuring device. DE 10 2017 121 587 A1 discloses a method comprising irradiating a sample containing the fluid and the particles with an input light beam having a plurality of wavelengths, and measuring a spectral transmission with an extinction arrangement.

In the prior art, the Beer-Lambert law is specifically used for extinction arrangements in order to carry out a simultaneous analytical calculation of the size and concentration of the particles from the mean value and the standard deviation of the signal (see, Benno Wessely, Extinction Measurement Of Light For Characterizing Disperse Systems, Dissertation, T U Dresden: VDI-Verlag, 1999). For scattered light assemblies, such an evaluation has not hitherto been possible, since the detector signal cannot be described using the Beer-Lambert law.

There are numerous measurement tasks that require simultaneous analysis of particle size and concentration within a wide concentration range.

Only a scattered light arrangement can be considered for this purpose since, in single particle counting methods, they are significantly more sensitive to small particles compared to extinction arrangements (see, International Organization for Standardization (ISO), ISO Standard 21501-2:2019, Determination Of Particle Size Distribution, Single Particle Light Interaction Methods, Part 2: Light Scattering Liquid-borne Particle Count; and International Organization for Standardization (ISO), ISO Standard 21501-3:2019, Determination Of Particle Size Distribution, Single Particle Light Interaction Methods, Part 3: Light Extinction Liquid-borne Particle Counter). The known fluctuation analysis is in principle a collective evaluation extinction method and can therefore not be combined with a single particle counting scattered light arrangement.

The object is therefore to provide a method for measuring particles, which can be used over an increased concentration range and/or allows for simultaneous determination of the size and concentration of particles of a dispersion.

### SUMMARY

According to the invention, the object is solved by a method and a device according to the independent claims. Advantageous embodiments of the invention are specified in the dependent claims.

A first aspect of the invention relates to a method for measuring the size and concentration of particles of a dispersion, comprising: a) illuminating at least one measurement volume of a dispersion with at least one light source, wherein light beams of the at least one light source are scattered in the measurement volume by particles; b) time-dependent measurement of at least one scattered light signal of the at least one measurement volume of the dispersion by at least one photodetector, wherein a frequency distribution of a time-dependent scattered light signal is obtained; and c) computer-implemented determination of the size and/or concentration of the particles in the at least one measurement volume by means of a regression function from the frequency distribution of the time-dependent scattered light signal.

According to the invention, a time-dependent measurement, i.e., a fluctuation analysis, takes place in step b). Expediently, at least one light beam of the at least one light source runs along a beam path from the light source through the measurement volume to the at least one photodetector.

In the method according to the invention, a single particle counting scattered light method could be combined with a collective-evaluation evaluation mode for high concentrations. The previously existing concentration gap between single particle counting methods and collective evaluation methods is thus advantageously closed.

Advantageously, the method according to the invention (additive fluctuation analysis) allows simultaneous determination of size and concentration information.

The relationship between scattered light signal and size and concentration information is expediently obtained by a regression of statistical parameters of the signal path over time. This is to be understood as meaning that the individual measured values of the signal path over time are converted into a histogram.

Since the recorded scattered light signal collectively contains the properties of all particles of the dispersion investigated, the method according to the invention advantageously makes it possible to determine the concentration and size of a plurality of particles over a wide concentration range and size range on the basis of only one measurement.

Furthermore, the use of a regression function advantageously compensates for device-specific properties which would act as defects in analytical solutions.

The term “dispersion” as used herein is understood to mean a heterogeneous mixture of at least two substances which do not dissolve or hardly dissolve in one another or chemically bond with one another, wherein at least one substance is present as particles distributed in at least one other substance.

In embodiments, the dispersion is a mixture of particles in at least one fluid, preferably in at least one gas, i.e., an aerosol; or in at least one liquid, i.e., a disperse liquid.

In embodiments, the dispersion is a mist (liquid particles in at least one gas), a smoke (solid particles in at least one gas), a suspension (solid particles in at least one liquid) or an emulsion (liquid particles in at least one liquid).

In preferred embodiments, the dispersion is an aerosol.

The term “measurement volume” as used herein is understood to mean a region, in particular a specific volume, of a dispersion which is illuminated by at least one light source, and which is detected by at least one photodetector.

The term “scattered light” as used herein is understood to mean light radiation which is deflected by interaction with the particles of the dispersion. The scattered light has a different intensity over the solid angle.

In embodiments, the time-dependent measurement in step b) takes place at least over a period which is necessary to determine the frequency distribution of the at least one scattered light signal with sufficient statistical certainty. Typically, the measurement period is between one second and a few minutes. In preferred embodiments, the time-dependent measurement in step b) takes place for a period in the range of 1 s to 2 min.

In embodiments, in step a), at least two differently sized measurement volumes through which the dispersion flows are illuminated by at least one light source, and in step b) a time-dependent measurement of at least one scattered light signal of at least two differently sized measurement volumes of a dispersion is carried out simultaneously or successively.

In embodiments, in step b), a time-dependent measurement of a scattered light signal is carried out by a photodetector, wherein the first measurement volume and the second measurement volume are measured one after the other, i.e., offset over time.

In further embodiments, in step b), a time-dependent measurement of two scattered light signals is carried out by two photodetectors, wherein the first measurement volume and the second measurement volume are measured simultaneously, i.e., at the same time.

In embodiments, the at least two differently sized measurement volumes have a size ratio in the range of 1:2 to 1:1,000, preferably of 1:10 to 1:100.

Expediently, the measurement volume is adjusted by varying the diameter or the beam height of the light source, in particular the height of the laser beam, preferably by using at least one lens, at least one aperture, or at least one beam expander, or by varying the dispersion beam, in particular by using at least one nozzle.

In embodiments, the scattered light signal is measured by the at least one photodetector at an angle in the range of 10° to 170°, preferably in the range of 45° to 135°, preferably in the range of 85° to 95°, starting from non-scattered light beams of the at least one light source penetrating the measurement volume.

In embodiments, the at least one light source is a laser. In embodiments, the scattered light signal is measured by the at least one photodetector at an angle in the range of 10° to 170°, preferably in the range of 45° to 135°, particularly preferably in the range of 85° to 95°, to the optical axis of the laser.

According to the invention, the size and/or concentration of the particles of the dispersion is calculated on the basis of the frequency distribution of the time-dependent scattered light signal in step c). In embodiments, the basis for the calculation is a regression of frequency distributions of dispersions with particles of known size and concentration.

The term “regression” as used herein is understood to mean a relationship between two or more variables, in particular the size and concentration of the particles and photodetector signal. In the regression analysis, it is assumed that there is a directed relationship, i.e., a dependent variable and at least one independent variable exist.

The term “frequency distribution” as used herein is understood to mean a function which indicates with which probability a certain value of the photodetector signal occurs.

In embodiments, a histogram is created using measurements with dispersions having particles of known size and concentration. In embodiments, the histogram is fed to a neural network or described with a regression fit.

In embodiments, the statistical signal parameters obtained from the regression fit are supplied to an analytical regression.

In alternative embodiments, a neural network is trained on the basis of measurements with dispersions having particles of known size and concentration or, on the basis of measurements with dispersions having particles of known size and concentration, a histogram is obtained from the coefficients of a first regression fit, e.g., mean value and standard deviation, wherein the coefficients obtained are used for determining the size and/or concentration in step c).

A further aspect of the invention relates to a device for measuring the size and concentration of particles of a dispersion, comprising: a) a measuring cell for a dispersion comprising at least one measurement volume; b) at least one light source, wherein the measurement volume is illuminated by the light source; c) at least one photodetector, wherein the photodetector measures the scattered light from the at least one measurement volume; and d) a data processing unit comprising a processor that is configured to execute step c) of the method according to the invention.

The device according to the invention is advantageously equally suitable for single particle counting and collective evaluation methods. Advantageously, the device according to the invention can also be used to determine a concentration in the range of 0.1<cₘ·Vₘ<10, where cₘ is the number concentration and Vₘ is the measurement volume, in which neither single particle counting nor collective evaluation methods can otherwise be used.

The term “measuring cell” as used herein is understood to mean an element of the device which is designed such that it can accommodate the measurement volume of the dispersion.

In embodiments, the measuring cell comprises an inlet for the dispersion and an outlet for the dispersion.

In embodiments, the measuring cell is a flow-through cell. Advantageously, the dispersion can be passed through as a particle stream in a flow-through cell.

In embodiments, the measuring cell is designed to be at least partially transparent, in particular the measuring cell comprises an at least partially transparent measuring portion.

The term “photodetector” (also optical detector or optoelectronic sensor) as used herein is understood to mean an electronic component which converts light into an electrical signal by means of the photoelectric effect or has an electrical resistance which is a function of the light radiation. In embodiments, the at least one photodetector is a photomultiplier, a silicone photomultiplier (SiPM), a photocell, a photodiode, or a phototransistor.

In embodiments, the at least one photodetector is designed such that it measures scattered light at an angle in the range of 10° to 170°, preferably in the range of 45° to 135°, particularly preferably in the range of 85° to 95°, starting from non-scattered light beams of the light source penetrating the measurement volume.

The term “light source” as used herein is understood to mean an element which generates and emits light. The at least one light source is expediently designed such that the measurement volume is illuminated. In embodiments, the at least one light source is a directionally radiating light source. In embodiments, the light beam spreads from the light source parallel to or along an optical axis (main emission direction of the light source). The optical axis expediently intersects the measuring cell (particle measurement portion).

In embodiments, the at least one light source is a laser. In embodiments, the at least one photodetector is arranged at an angle in the range of 10° to 170°, preferably in the range of 45° to 135°, particularly preferably in the range of 85° to 95°, to the optical axis of the laser.

In further embodiments, the at least one light source is a laser having a beam height in the range of 20 μm to 0.5 mm.

In embodiments, the at least one light source is arranged at an angle in the range of 10° to 170°, preferably 45° to 135°, particularly preferably 85° to 95°, to the flow direction of the particle stream through the measuring cell.

Preferably, the at least one light source and/or the at least one photodetector is temperature compensated.

In embodiments, the measuring cell comprises at least two differently sized measurement volumes. Advantageously, the maximum concentration of the single particle analysis and minimum concentration of the collective evaluation overlap by the differently sized measurement volumes in each case. A smooth transition between single particle analysis and fluctuation analysis is thus possible. The arrangement can thus provide both size information and concentration information of the particle stream over an extremely wide concentration range.

In embodiments, the at least two measurement volumes have a size ratio in the range of 1:2 to 1:1,000, preferably of 1:10 to 1:100.

In embodiments, the measuring cell comprises at least two differently sized, spatially separated measurement volumes, preferably with a size ratio in the range of 1:2 to 1:1,000, preferably 1:10 to 1:100.

In embodiments, the size of the measurement volume is adjustable and can be adjusted in a size ratio in the range of 1:2 to 1:1,000, preferably 1:10 to 1:100.

In preferred embodiments, an adjustment of the size of the measurement volume is achieved by using at least one aperture, a polarization filter, a liquid crystal display aperture, or a beam expander.

Advantageously, the height of the at least one light source and the measurement volume can be adapted by the at least one aperture and/or a beam expander.

In alternative embodiments, the device comprises a polarization filter or a liquid crystal display (LCD aperture). The term “polarization filter” as used herein is understood to mean a polarizer for light which absorbs complementarily polarized light. The term “liquid crystal display” as used herein is understood to mean a unit comprising liquid crystals, wherein the liquid crystals change the polarization direction of light when a certain amount of electrical voltage is applied. Advantageously, the height of the at least one light source and the measurement volume can be adapted by the polarization filter or the liquid crystal display.

In embodiments, the device comprises at least two light sources and/or at least two photodetectors.

In embodiments, the first light source, preferably a first laser, and the second light source, preferably a second laser, are arranged in such a way that the optical axes of the light sources are arranged at an angle in the range of 10° to 170° relative to one another.

In embodiments, the first light source and the second light source are each independently at an angle in the range of 10° to 170°, preferably 45° to 135°, particularly preferably 85° to 95°; to the flow direction of the particle stream through the measuring cell.

In embodiments, the first light source, preferably a first laser, and the second light source, preferably a second laser, are arranged in such a way that the measuring cell is illuminated at the same position or at different positions and/or that the first and the second measurement volumes overlap or are spatially separated from one another.

In embodiments, the device comprises at least two light sources and at least two photodetectors.

In embodiments, the device additionally comprises at least one color filter which is designed such that only the scattered light of the at least one light source is transmitted.

In embodiments, the device comprises at least two light sources, preferably at least two lasers, at least two color filters and at least one photodetector.

In embodiments, the device comprises at least two light sources, preferably two lasers, at least two color filters and at least two photodetectors.

In embodiments, the device comprises two light sources, preferably two lasers, two color filters and two photodetectors.

In embodiments, the first light source, preferably a first laser, and the second light source, preferably a second laser, are arranged in such a way that the optical axes of the light sources are arranged at an angle in the range of 45° to 185°, preferably 90° 180° relative to one another.

In embodiments, the first photodetector is designed such that it measures scattered light at an angle in the range of 10° to 170°, preferably approximately 90°, starting from non-scattered light beams of the first light source penetrating the measurement volume. In embodiments, the second photodetector is designed such that it measures scattered light at an angle in the range of 10° to 170°, preferably approximately 90°, starting from non-scattered light beams of the second light source penetrating the measurement volume.

In embodiments, the first color filter is designed such that only the scattered light of the first light source is transmitted and/or the second color filter is designed such that only the scattered light of the second light source is transmitted.

In embodiments, the device comprises a second measuring cell for a dispersion comprising at least one second measurement volume, wherein the first measurement volume and the second measurement volume have a size ratio in the range of 1:2 to 1:1,000, preferably of 1:10 to 1:100. In embodiments, the first and second measuring cells each comprise a light source and a photodetector.

In embodiments, the first and second measuring cells are arranged in parallel or in succession in the flow direction of the particle stream of the dispersion.

In embodiments, the device furthermore comprises at least one nozzle at the inlet of the dispersion into the measuring cell. Advantageously, the diameter of the dispersion and thus the measurement volume can be varied over time by a nozzle.

In embodiments, the device furthermore comprises at least two nozzles at the inlet of the dispersion into the measuring cell, wherein the first and second nozzle have different diameters. The diameter of the dispersion and thus the measurement volume can advantageously be varied over time by using at least two nozzles having different diameters.

Each program-controlled data processing device is regarded as a data processing unit. In embodiments, the data processing unit and/or one or more components of the data processing unit is formed by a data processing system. In embodiments, the data processing system comprises one or more components in the form of hardware and/or one or more components in the form of software.

In embodiments, the data processing unit or the data processing system is at least partially formed by a cloud computing system. In embodiments, the data processing unit or the data processing system is a cloud computing system, a computer network, a computer, a tablet computer, a smartphone, or a combination thereof.

In embodiments, hardware interacts with software and/or can be configured by means of software. Expediently, the software is run by means of the hardware. In embodiments, the hardware is a storage system, an FPGA system (field programmable gate array), an ASIC system (application-specific integrated circuit), a microcontroller system, a processor system, or a combination thereof.

In embodiments, the data processing unit further comprises at least one training data set, wherein the training data set comprises measurements with dispersions having particles of known size and concentration.

A further aspect of the invention relates to the use of the device according to the invention for measuring the size and/or concentration of particles of a dispersion.

Furthermore, a computer program product comprising commands which, when the program is run by a computer, causes the computer to carry out step c) of the method according to the invention, is also included.

In embodiments, the computer program product is loadable in a storage device of the data processing unit.

Another aspect of the invention relates to a computer-readable medium on which program portions that can be read and run by a data processing system are stored in order to carry out step c) of the method according to the invention when the program portions are run by the data processing system.

In order to realize the invention, it is also expedient to combine the above-described embodiments according to the invention, the exemplary embodiments, and the features of the claims with one another.

The invention is explained in more detail below with reference to an exemplary embodiment. The exemplary embodiment is intended to describe the invention without limiting it.

### BRIEF DESCRIPTION OF THE DRAWINGS

The invention is explained in more detail with reference to the drawings.

FIG. 1 illustrates a device according to the present disclosure with a particle stream, at least one light source, and at least two photodetectors, in accordance with an embodiment of the present disclosure;

FIG. 2 illustrates a device with a particle stream, two light sources, two color filters and two photodetectors, in accordance with an embodiment of the present disclosure;

FIG. 3A illustrates a graph showing a time-dependent measurement of a scattered light signal in a measurement volume of an aerosol by a photodetector, in accordance with an embodiment of the present disclosure;

FIG. 3B illustrates a graph showing a frequency distribution of a time-dependent scattered light signal, in accordance with an embodiment of the present disclosure;

FIG. 3C illustrates a graph showing a distribution fit of a determination of the size and/or concentration of particles of an aerosol in a measurement volume, in accordance with an embodiment of the present disclosure; and

FIG. 3D illustrates a graph showing a polynomial function of a determination of the size and/or concentration of particles of an aerosol in a measurement volume, in accordance with an embodiment of the present disclosure.

### DETAILED DESCRIPTION

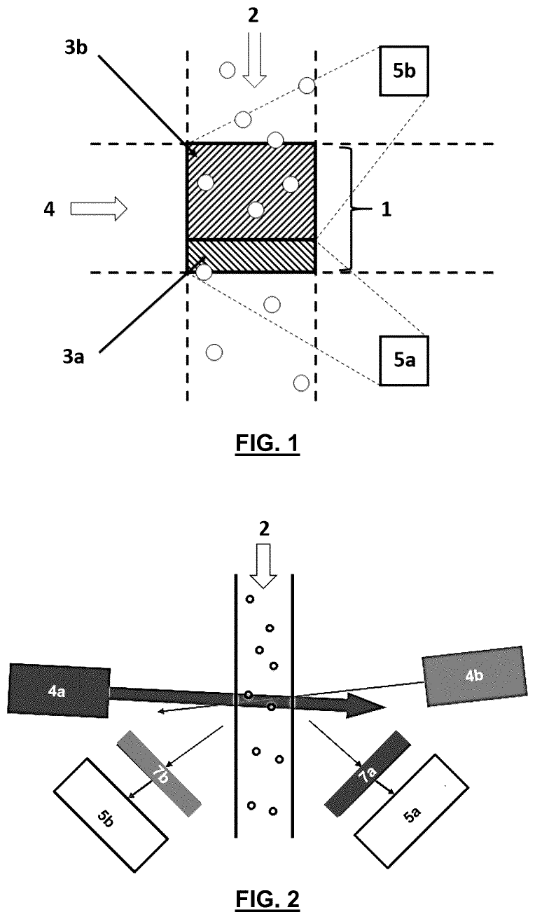

FIG. 1 shows a device according to the invention consisting of a particle stream 2, at least one light source 4, and at least two photodetectors 5a, 5b. The particle stream 2, the region illuminated by the light source (measuring cell 1) and the region mapped on a detector form a measurement volume 3. The device is designed such that at least two differently sized measurement volumes 3a, 3b result. The second measurement volume 3b is substantially greater than the first measurement volume 3a. The first photodetector Sa receives only the light from the first measurement volume 3a and the second photodetector 5b receives only the light from the second measurement volume 3b.

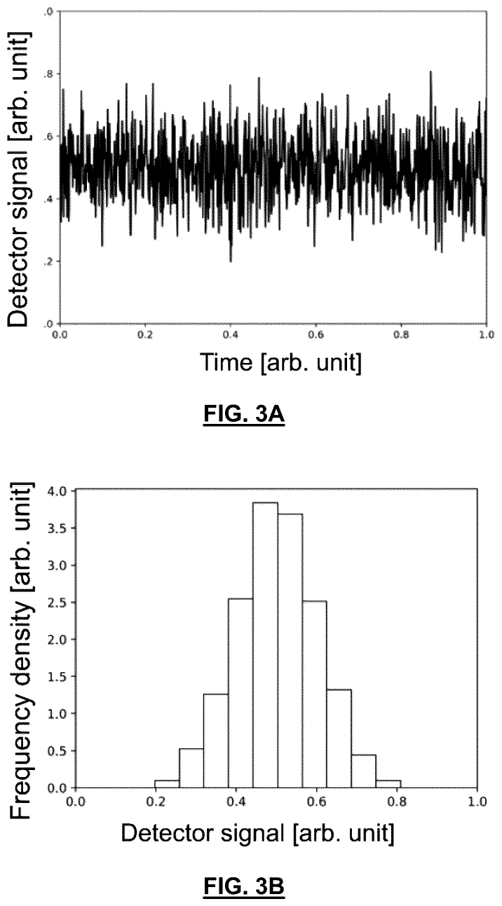

FIG. 2 shows a device according to the invention consisting of a particle stream, two light sources 4a, 4b, two color filters 7a, 7b and two photodetectors Sa, 5b. The particle stream, the region illuminated by the light source (measuring cell) and the region mapped on a detector form a measurement volume. The device is designed such that at least two differently sized measurement volumes are determined by using two lasers 4a, 4b having different heights and different wavelengths. The second measurement volume is substantially greater than the first measurement volume (approx. 50:1). The photodetector 5a receives only the light from the first measurement volume by using a first color filter 7a which only transmits the scattered light of the first light source 4a, and the second photodetector 5b receives only the light from the second measurement volume by using a second color filter 7b which only transmits the scattered light of the second light source 4b. Arrangement of the first and second light sources 4a, 4b at an angle of 180° to one another and arrangement of the first and second photodetector Sa, 5b at an angle of 180° to one another and in each case at an angle of 90° to the first or second light source, 4a, 4b.

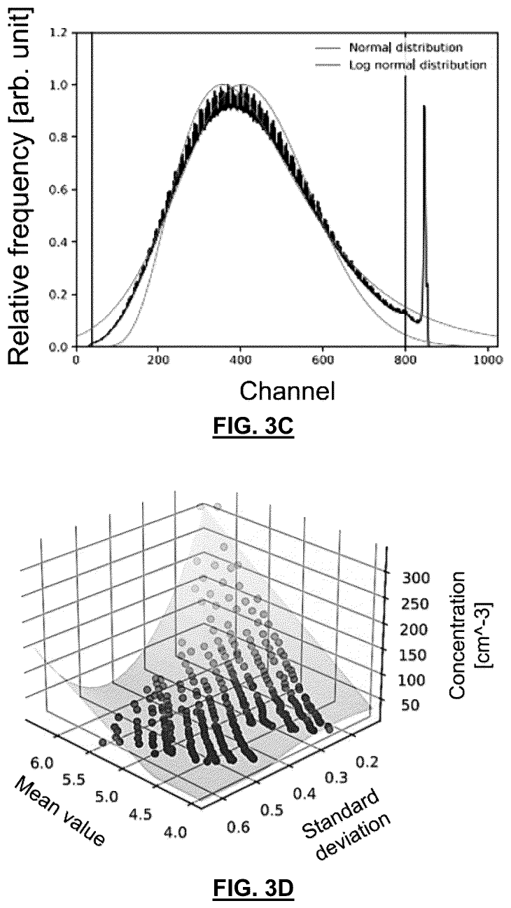

FIG. 3A shows a time-dependent measurement of a scattered light signal in a measurement volume of an aerosol by a photodetector. FIG. 3B shows an obtained frequency distribution of a time-dependent scattered light signal, and the computer-implemented determination of the size and/or concentration of the particles of the aerosol in the measurement volume by means of a regression function from the frequency distribution of the time-dependent scattered light signal. FIG. 3C shows a distribution fit of the data of FIG. 3B, and FIG. 3D shows a polynomial regression function used to calculate size or concentration of the aerosol, based on the parameters of the distribution fit of FIG. 3C.

In one example, an aerosol is measured using a method in accordance with the invention. A quasi-monodisperse DEHS (di-ethylhexyl sebacate) aerosol is produced using a Sinclair-La Mer generator. The generator system is designed such that both size and concentration can be varied. Different points in a characteristic map are run with these two parameters. For each point, a suitable reference measurement is carried out using a reference method (e.g., optical aerosol spectrometer). The mean value and standard deviation of a log normal distribution are calculated at the recorded frequency distributions. With these two parameters, a regression is carried out on the results of the reference method.

The regression function obtained can then be used to calculate particle size and concentration from a newly measured frequency distribution.

We claim:

1. A method for measuring at least one of the size and the concentration of particles of a dispersion, comprising:
illuminating at least one measurement volume of a dispersion with at least one light source, wherein light beams of the at least one light source are scattered by particles of the dispersion in the at least one measurement volume,
performing a time-dependent measurement of at least one scattered light signal of the at least one measurement volume of the dispersion by at least one photodetector, wherein the measurement comprises obtaining a frequency distribution of a time-dependent scattered light signal of the at least one scattered light signal; and
determining at least one of the size and concentration of the particles of the dispersion in the at least one measurement volume by means of a computer-implemented regression function from the obtained frequency distribution of the time-dependent scattered light signal.

2. The method according to claim 1, wherein illuminating the at least one measurement volume comprises illuminating at least two differently sized measurement volumes of the at least one measurement volume of the dispersion with the at least one light source.

3. The method according to claim 2, wherein the at least two differently sized measurement volumes are spatially separated.

4. The method according to claim 2, wherein performing the time-dependent measurement comprises performing a time-dependent measurement of at least two scattered light signals of the at least two differently sized measurement volumes of the dispersion.

5. The method according to claim 4, wherein the at least two differently sized measurement volumes have a size ratio in the range of 1:2 to 1:1,000.

6. The method according to claim 5, wherein performing the time-dependent measurement of the at least one scattered light signal comprises measuring the at least one scattered light signal by the at least one photodetector at an angle in the range of 10° to 170° from non-scattered light beams of the at least one light source penetrating the at least one measurement volume.

7. The method according to claim 6, further comprising obtaining the computer-implemented regression function by means of regression analysis as a polynomial function or by means of a neural network.

8. The method according to claim 1, wherein performing the time-dependent measurement of the at least one scattered light signal comprises measuring the at least one scattered light signal by the at least one photodetector at an angle in the range of 10° to 170° from non-scattered light beams of the at least one light source penetrating the at least one measurement volume.

9. The method according to claim 1, further comprising obtaining the computer-implemented regression function by means of regression analysis as a polynomial function or by means of a neural network.

10. A device for measuring at least one of the size and concentration of particles of a dispersion, comprising:
a measuring cell configured to contain a dispersion;
at least one light source configured to illuminate at least one measurement volume of the dispersion in the measuring cell;
at least one photodetector configured to measure scattered light from the at least one measurement volume when illuminated by the at least one light source; and
a data processing unit comprising a processor configured to determine at least one of the size and concentration of particles of the dispersion in the at least one measurement volume via a regression function from a frequency distribution of a time-dependent scattered light signal of the scattered light.

11. The device according to claim 10, wherein the at least one photodetector is arranged at an angle in the range of 10° to 170° to an optical axis of the at least one light source.

12. The device according to claim 10, wherein the device is configured such that the at least one measurement volume comprises at least two differently sized measurement volumes, and wherein the at least one photodetector is configured to measure scattered light from the at least two measurement volumes.

13. The device according to claim 12, wherein the data processing unit is configured to determine at least one of the size and concentration of particles of the dispersion in the at least two measurement volumes via a regression function from a frequency distribution of a time-dependent scattered light signal of the scattered light.

14. The device according to claim 13, wherein the at least one light source comprises at least two light sources, and wherein the at least two light sources are configured to at least partially form the at least two differently sized measurement volumes.

15. The device according to claim 14, wherein the at least one photodetector comprises at least two photodetectors, and wherein the at least two photodetectors are configured to respectively measure scattered light from the at least two measurement volumes when illuminated by the at least two light sources.

16. The device according to claim 13, wherein the measuring cell comprises at least one nozzle at an inlet of the dispersion, and wherein the at least one nozzle is configured to at least partially form the at least two differently sized measurement volumes.

17. The device according to claim 12, wherein the at least two differently sized measurement volumes are spatially separated.

18. The device according to claim 12, wherein the at least two differently sized measurement volumes have a size ratio in the range of 1:2 to 1:1,000.

19. The device according to claim 10, further comprising at least one color filter configured such that only the scattered light from the at least one light source is transmitted to the at least one photodetector.

20. A computer program product, comprising:
a computer-readable medium readable by one or more processing unit and storing instructions for execution by one or more processor for performing a method of measuring at least one of the size and the concentration of particles of a dispersion, comprising:
performing a time-dependent measurement of at least one scattered light signal of light scattered by at least one measurement volume of the dispersion via at least one photodetector, wherein the measurement comprises obtaining a frequency distribution of a time-dependent scattered light signal of the at least one scattered light signal; and
determining at least one of the size and concentration of the particles of the dispersion in the at least one measurement volume by means of a regression function from the obtained frequency distribution of the time-dependent scattered light signal.
